(19) United States
(12) Patent Application Publication
(10) Pub. No.: US 2011/0318953 A1
(43) Pub. Date: Dec. 29, 2011

(54) SHEAR FASTENER

(76) Inventor: Robert James Battle, Yatala (AU)

(21) Appl. No.: 13/230,406

(22) Filed: Sep. 12, 2011

Related U.S. Application Data
(63) Continuation of application No. 12/267,118, filed on Nov. 7, 2008, now Pat. No. 8,016,622.

(51) Int. Cl. H01R 13/627; F16B 31/00

(52) U.S. Cl. 439/359; 411/2

(57) ABSTRACT

The present invention relates to a shear fastener for an electrical connector. The fastener includes a head from which a threaded shaft extends. The head defines a pair of polygonal portions separated by a recess so that an endmost one of the polygonal portions can be separated from the fastener by shearing as the fastener is tightened within the connector. Separation of opposite flats of the endmost polygonal portion is different (e.g. greater) than separation of opposite flats of the other polygonal portion. In one embodiment, the engagement socket of a pneumatic wrench can slip over the polygonal portions and rotate through 360° when rapidly tightening the fastener whilst engaging with the endmost polygonal portion, without engaging with the other polygonal portion.

### TECHNICAL FIELD

The present invention relates to a shear fastener for an electrical connector. The present invention also relates to an electrical connector including the shear fasteners. The present invention has particular, although not exclusive application to mains-power electrical connectors used in underground power distribution systems.

### BACKGROUND

The reference to any prior art in this specification is not, and should not be taken as an acknowledgement or any form of suggestion that the prior art forms part of the common general knowledge.

Mains-power electrical connectors are used for connecting two or more mains-power (e.g. 110V, 240V, 415V, etc.) electrical cables together. In underground power distribution systems, for example, lengths of insulated cable are serially connected together (i.e. daisy chained) using mains-power connectors which are located within protective “pillar” boxes, pits or handholes.

These connectors typically include a connector body. The connector body includes an electrically conductive core defining passages for receiving respective cables, and apertures for receiving fasteners to fasten the cables within the passages. The connector body further includes a protective insulator cover which covers the core. In use, a respective cable is located in each passage and the fasteners are engaged within the passages so as to clamp the cables therein and form an electrical connection between the cables via the core (and fasteners). The cables can be stripped of their insulation before fastening or, in some applications, the base of the fastener may include opposed piercing teeth for piercing the cable insulation.

The fasteners are often shear bolts including a head from which a threaded shaft extends. The head defines a pair of hexagonal portions separated by a recess so that an endmost one of the hexagonal portions can be separated from the fastener by shearing as the fastener is tightened within the connector body. The fastener can later be un-tightened using the remaining hexagonal portion if the cable needs to be removed from the connector when, for example, reconfiguring the power distribution system of which it forms a part.

In practice, a spanner (or other like tightening tool) engaging with the fastener head during tightening can undesirably slip to the innermost hexagonal portion which impedes the endmost hexagonal portion from shearing and separating from the fastener. Furthermore, the spanner may slip off the fastener head during tightening, if it is not correctly aligned to sit squarely on the fastener head.

It is an object of the present invention to provide a fastener which ameliorates at least one of the foregoing tightening problems.

### SUMMARY OF THE INVENTION

According to one aspect of the present invention, there is provided a shear fastener for an electrical connector, the fastener including a head from which a threaded shaft extends, the head defining a pair of polygonal portions can be separated from the fastener by shearing as the fastener is tightened within the connector, separation of the opposite flats of the endmost polygonal portion being different than separation of opposite flats of the other polygonal portion.

Advantageously, a tightening tool can engage with the flats of the endmost polygonal portion and tighten the fastener without being able to engage with the flats of the other polygonal portion. A pneumatic wrench, with a bit that can be rotated through 360° during tightening, can be used to rapidly tighten the fasteners.

The recess may be inwardly tapered. The recess may endlessly extend around the head.

Each polygonal portion may be hexagonal.

The head may define a cap extending from the polygonal portions. The cap may define an endless clamping recess located between a resilient outer skirt and a central hub. The cap may define a flat roof surface against which a tightening tool can be pressed during tightening of the fastener. The shaft may define a ribbed tip which can be force fitted into a cavity defined in the hub. The shaft may further define a locating ledge separating the ribbed tip from a threaded portion.

The head may be integrally formed from nylon, steel, brass, copper, plastic or aluminum material.

According to another aspect of the present invention, there is provided a mains-power electrical connector including:
a connector body defining passages for receiving respective cables, and apertures for receiving fasteners to fasten the cables within the passages; and
one or more of the fasteners for engaging within respective apertures.

According to another aspect of the present invention, there is provided a shear fastener for an electrical connector, the fastener including a head from which a threaded shaft extends, the head defining a pair of polygonal portions separated by a recess so that an endmost one of the polygonal portions can be separated from the fastener by shearing as the fastener is tightened within the connector, separation of opposite corners of the endmost polygonal portion being different than separation of opposite corners of the other polygonal portion.

According to another aspect of the present invention, there is provided a shear fastener for a mains-power electrical connector, the fastener including a head from which a threaded shaft extends, the head defining a pair of polygonal portions separated by a recess so that an endmost one of the polygonal portions can be separated from the fastener by shearing as the fastener is tightened within the connector, the endmost portion having a cross sectional area transverse to the fastener different than the other portion.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an upper rear perspective view of a mains-power electrical connector in accordance with an embodiment of the present invention;

FIG. 2 is an upper front partially exploded perspective view of the mains-power electrical connector of FIG. 1;

FIG. 3 is an upper front partially exploded perspective view of a core of the mains-power electrical connector of FIG. 1;

FIG. 4a is a plan view of the mains-power electrical connector of FIG. 1;

FIG. 4b is a front view of the mains-power electrical connector of FIG. 4a sectioned through the line A-A;

FIG. 5 is an exploded lower perspective view of a fastener of the mains-power electrical connector of FIG. 1; and

FIG. 6 is a side sectioned view of the fastener of FIG. 5.

### DETAILED DESCRIPTION OF PREFERRED EMBODIMENTS

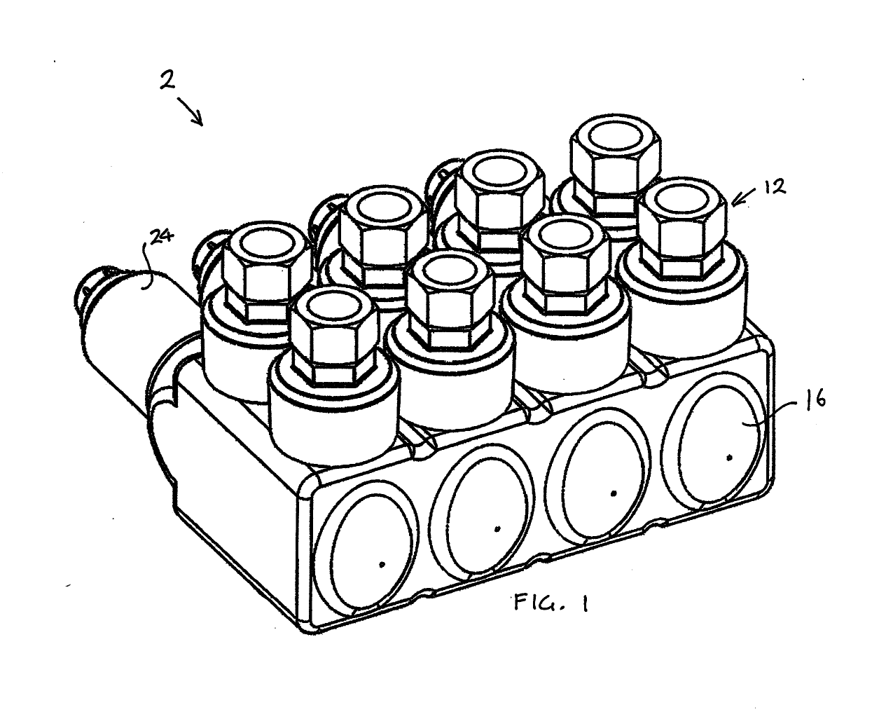

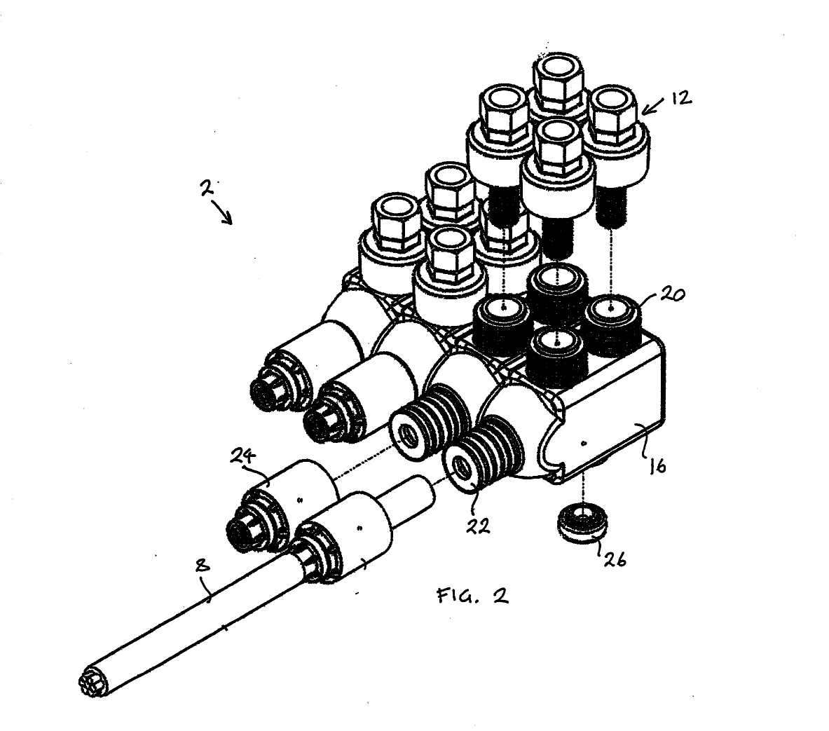

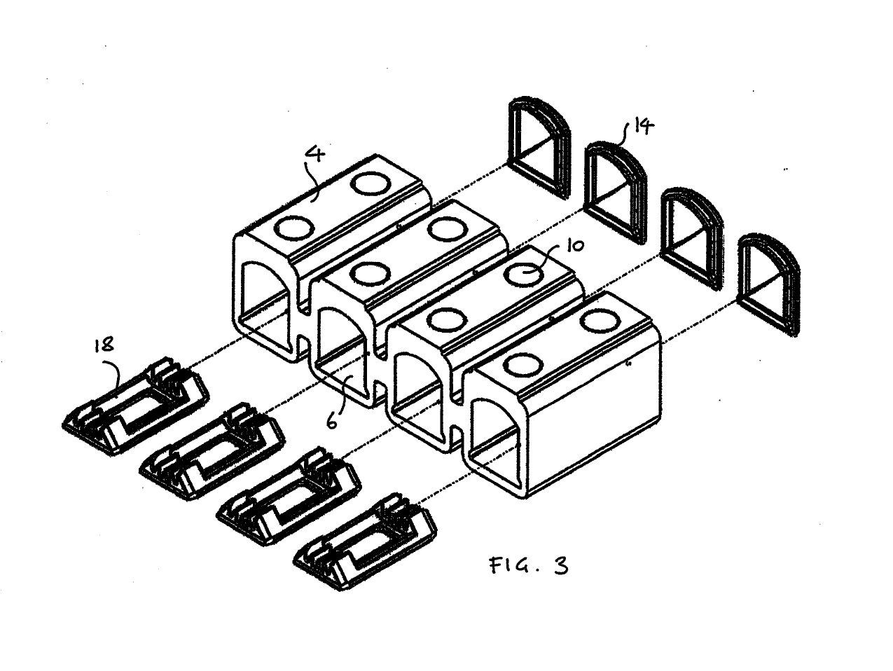

According to an embodiment of the present invention, there is provided a mains-power electrical connector 2 as shown in FIGS. 1 and 2. Turning briefly to FIG. 3, the connector 2 includes an electrically conductive core 4 defining passages 6 for receiving respective multi-strand cables 8, and apertures 10 for receiving fasteners 12 to fasten the cables 8 within the passages 6. Transparent windows 14 terminate the passages 6. Turning to FIG. 1, a light-penetrable cover 16 covers the core 4 and the windows 14, and a user can discern the cable ends within the core 4 through the cover 16 when fastening the cables 8 within the passages 6. Moisture is impeded from entering the connector 2 about the windows 14, as the cover 16 wholly covers the windows 14 and there is no joining seam there-between. The connector 2 is described in detail below.

Returning to FIG. 3, the electrically conductive core 4 includes extruded aluminum and defines a quartet of parallel passages 6. A pair of fastener apertures 10 extends from each passage 6. Each fastener aperture 10 is threaded to complementarily engage with a threaded shaft of a fastener 12.

The connector 2 further includes a quartet of teeth assemblies 18 for force fitting into respective passages 6. Each teeth assembly 18 is formed from tinned high pressure cast brass and is electrically conductive. Each teeth assembly 18 rests on the floor of its passage 6. In use, the fastener 12 presses the cable 8 against the teeth assembly 18 which, in turn, pierces the cable insulation and forms an electrical connection between the cable 8 and the core 4 via the teeth assembly 18. Alternatively, the cable end may be stripped of its insulation before being inserted into the passage 6 and the teeth assembly 18 bites the cable 8 to impede its removal.

Each clear window 14 includes a generally curved viewing portion that protrudes outwardly beneath the cover 16 from its passage 6 as can best be seen in FIG. 1. The curved viewing portion provides structural stability to impede shattering of the window 14 when the cover 16 is applied to cover the core 4 and windows 14. Each window 14 also includes an endless skirt depending from the curved viewing portion. The skirt is configured to be force fitted within its passage 6.

The light penetrable cover 16 is integrally molded from translucent Styrene-Ethylene/Butylene-Styrene (SEBS) polymer and is homogeneous. Advantageously, the translucent cover 16 manifests the discernable contrast between a fully and partially inserted cable 8 whereby the cable 8 is only visible when in close proximity to the cover 16. Accordingly, the cable 8 is only clearly discernable when fully inserted into the passage 6 which signals the user to only then fasten the cable 8 within the passage 6 with the fasteners 12.

The cover 16 is an electrical insulator integrally formed from elastically resilient material. Turning to FIG. 2, the cover 16 defines a top set of inlet stems 20 for receiving the fasteners 12 and a side set of inlet stems 22 for receiving the cables 8. Each inlet stem 20, 22 is tubular and defines outer retention ribs. The outer retention ribs of the top inlet stems 20 impede removal of the fasteners 12 whereas the outer retention ribs of the side inlet stems 22 impede removal of tubular endcaps 24 force fitted thereon.

The cables 8 pass through the resilient endcaps 24 and into the passages 6. The side set of inlet stems 22 define inner ribs to form a watertight seal around larger cables 8. Each endcap 24 also defines internal retention ribs to impede removal of the endcap 24 from the inlet stem 22. The tubular endcaps 24 engage with respective side inlet stems 22 to form a water tight seal. The tubular endcaps 24 also form a water tight seal with the cables 8 passing there-through.

During molding of the cover 6 over the core 4 and windows 14, base holders (not shown) can be used to hold the core 4 in a fixed position within the mold. As can best be seen in FIG. 2, one or more plugs 26 may be required to plug holes formed in the cover 16 and in which the holders were situated during molding.

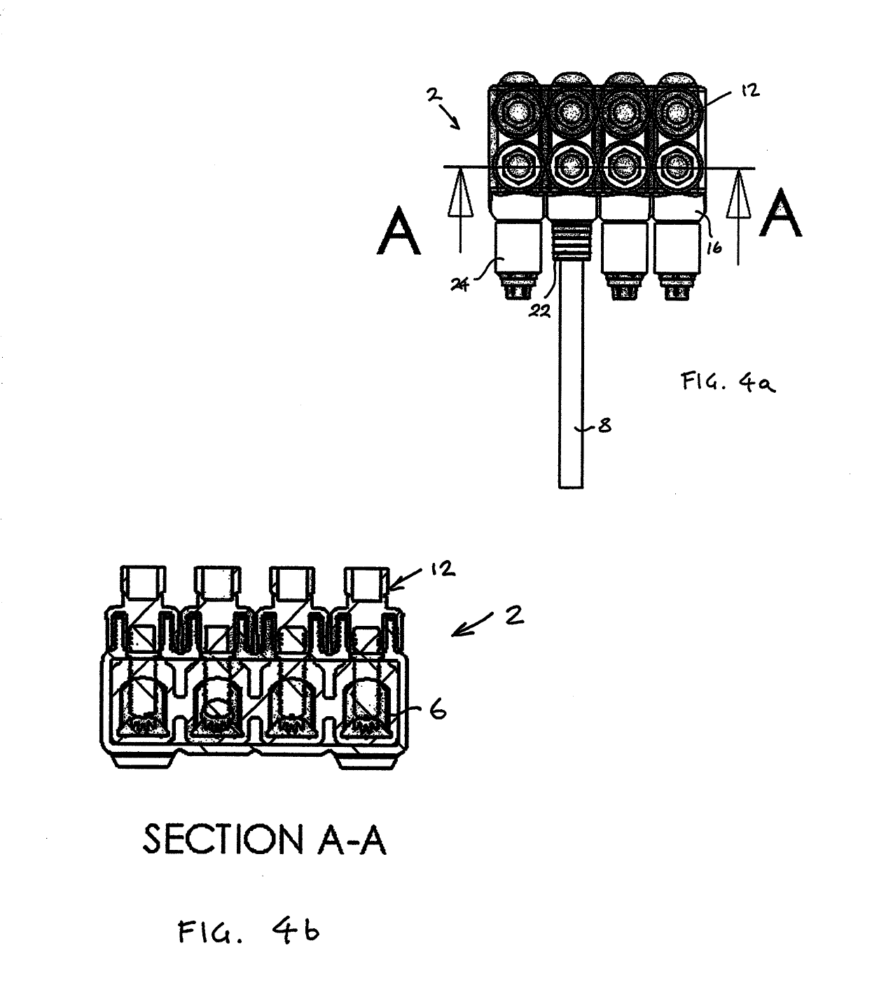

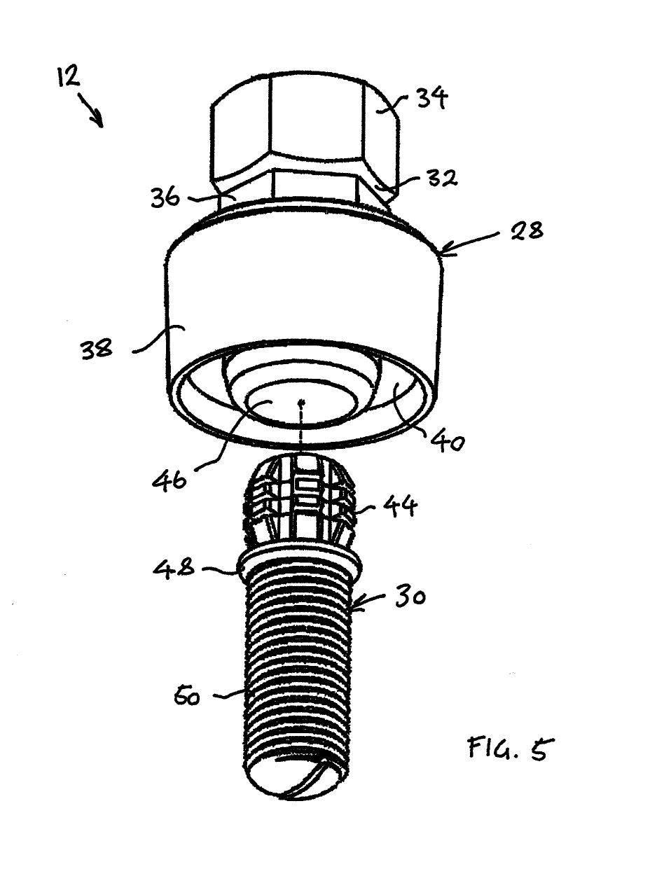

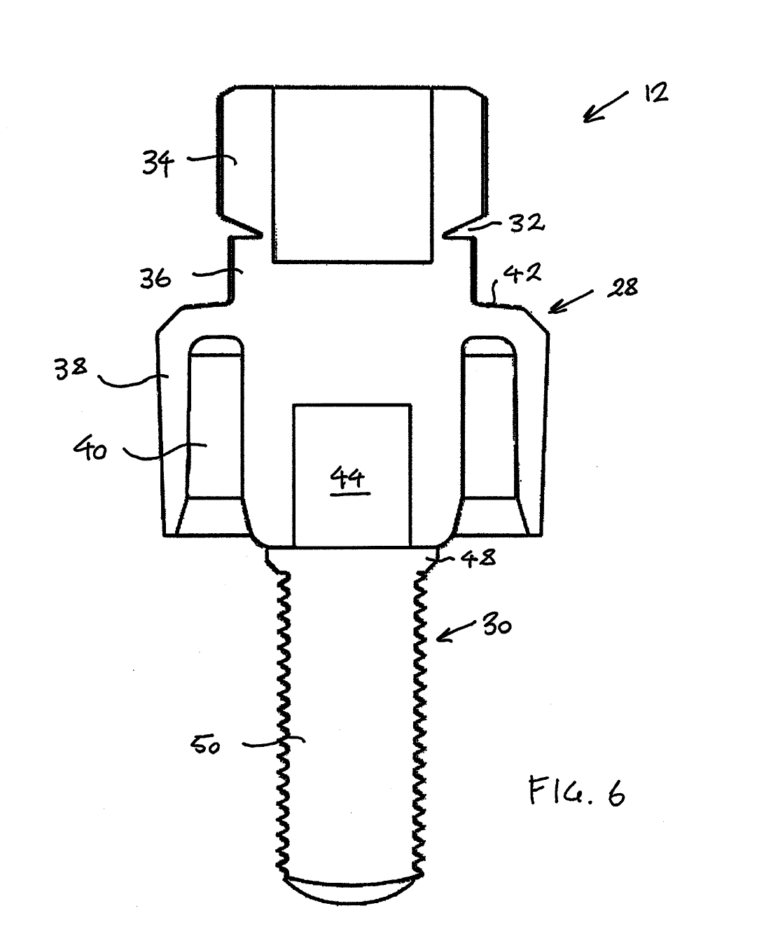

Turning to FIG. 4, the mains-power electrical connector 2 includes eight elongate fasteners 12, with two fasteners 12 to engage with the cable 8 in each passage 6. Turning to FIG. 5, each fastener 12 is a shear bolt and has a plastic head 28 from which a threaded shaft extends 30. The head 28 defines a recess 32 such that a hexagonal tip 34 of the head 28 can be separated from the fastener 12 by shearing as the fastener 12 is tightened within the connector 2 to fasten one of the cables 8. As can best be seen in FIG. 6, the recess 32 is inwardly tapered and continuously extends around the head 28.

The head 28 defines a pair of hexagonal portions 34, 36 on opposite sides of the recess 32. The separation of opposite flats of the endmost hexagonal portion 34 is greater than the separation of opposite flats of the innermost hexagonal portion 36. Accordingly, the cross sectional area of the endmost hexagonal portion 34 in a plane transverse to the fastener 12 is greater than the cross sectional area of the innermost hexagonal portion 36 in another plane transverse to the fastener 12. The flats of each hexagonal portion 34, 36 are the six flat edges with which a socket of a pneumatic (or impact) wrench can engage. It follows that separation of opposite corners of the endmost hexagonal portion 34 is greater than separation of opposite corners of the innermost hexagonal portion 36. Advantageously, the pneumatic wrench can engage with the flats of the endmost hexagonal portion 34 and tighten the fastener 12 without engaging with the flats of the innermost hexagonal portion 36. The pneumatic wrench has an engagement socket (or bit) that can slip over the hexagonal portions 34, 36 and rotate through 360° when rapidly tightening the fasteners 12.

The head 28 also defines a cap 38 extending downwardly from the hexagonal portions 34, 36. The cap 38 defines an endless recess 40 in which a top inlet stem 20 of the cover 16 is clamped to form a water tight seal. The cap 38 includes an elastically resilient outer skirt which clamps against the stem 20. The cap 38 defines a flat roof surface 42 against which the tightening socket of the pneumatic wrench can be pressed during tightening of the fastener 12.

As can best be seen in FIG. 5, the threaded shaft 30 defines a ribbed tip 44 which can be force fitted into a cavity 46 defined in a central hub of the cap 38. The shaft 30 also defines a protruding locating ledge 48 separating the ribbed tip 44 from a threaded tail 50. When the locating ledge 48 abuts the hub, the shaft 30 is correctly inserted into the cavity 46.

The manufacture and subsequent assembly of the connector 2 will now be briefly described.

Initially, the teeth assemblies 18 and windows 14 are force fitted into respective passages 6 of the core 4 as shown in FIG. 3. The passages 6 are terminated with respective windows 14 and the teeth assemblies 18 are wholly located within the passages 6.

Next, core 4 is placed within a mold. The cover 16 is molded over the core 4 and windows 14 so that the windows 16 are wholly located beneath the molded cover 16. The windows 14 and cover 16 are selected from materials so that no adhesive bond forms between them. The cover is molded at a carefully controlled temperature and pressure, each adjusted so that there is no breaking or melting of the window 14 during injection yet high enough to ensure complete molding of the cover 16. The actual values of temperature and pressure will be dependent on the size and type of molding machine.

The Styrene-Ethylene/Butylene-Styrene (SEBS) polymer cover material also provides a suitable degree of transparency so that the cables can be discerned within the passages 6.

The core is removed from the mold and the plugs 26 are inserted to plug holes formed in the cover 16 during molding.

The cables 8 are inserted either through respective endcaps 24 as shown in FIG. 2, or directly through the side inlet stem 22 as shown in FIG. 4a. The endcaps 24 are then pushed onto the side stems 22 to form a water tight seal. The cables 8 are pushed into the passages 6 until they abut the windows 14 and a user can discern them through the cover 16.

The fasteners 12 are then tightened within the core 4. The tightening socket of the pneumatic wrench slips over and engages with the flats of the endmost hexagonal portion 34 and screws the threaded shaft 50 into the threaded aperture 10. The shaft 50 pushes the cable 8 within the passage 6 against the teeth assembly 18 and thereby secures the cable 8. During tightening, the cap 38 is twisted onto the top stem 20 and forms a water tight seal. Accordingly, the corrosive components within the connector 2 are sealed within the water tight connector 2.

When each fastener 12 is tightened to a required extent, the endmost hexagonal portion 34 shears and separates from the fastener 12 and the tightening socket of the pneumatic wrench still does not engage with the innermost hexagonal portion 36. In order to un-tighten the fastener at a later stage, a narrower gauge socket can be fitted to the pneumatic wrench and engage with the flats of the innermost hexagonal portion 36.

A person skilled in the art will appreciate that many embodiments and variations can be made without departing from the ambit of the present invention.

In the preferred embodiment, a plurality of windows 14 terminated respective passages 6 defined within the core 4. In an alternative embodiment, the windows may be integrally formed together to form a single unit.

In the preferred embodiment, the fastener head 28 was molded from plastic material. Alternatively, the head 28 may be integrally formed from nylon, steel, brass, copper, or aluminum material.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A shear fastener for an electrical connector, the fastener including a head from which a threaded shaft extends, the head defining a pair of polygonal portions separated by a recess so that an endmost one of the polygonal portions can be separated from the fastener by shearing as the fastener is tightened within the connector, separation of opposite flats of the endmost polygonal portion being different than separation of opposite flats of the other polygonal portion.

2. A shear fastener as claimed in claim 1, wherein the recess is inwardly tapered and endlessly extends around the head.

3. A shear fastener as claimed in claim 1, wherein each polygonal portion is hexagonal and the separation of opposite flats of the endmost polygonal portion is greater than separation of opposite flats of the other polygonal portion.

4. A shear fastener as claimed in claim 1, wherein the head defines a cap extending from the polygonal portions, the cap defining an endless clamping recess located between a resilient outer skirt and a central hub.

5. A shear fastener as claimed in claim 4, wherein the cap defines a flat roof surface against which a tightening tool can be pressed during tightening of the fastener.

6. A shear fastener as claimed in claim 4, wherein the shaft defines a ribbed tip which can be forced fitted into a cavity defined in the hub, a locating ledge separating the ribbed tip from a threaded portion.

7. A shear fastener as claimed in claim 1, wherein the head is integrally formed from nylon, steel, brass, copper, plastic or aluminum material.

8. A mains-power electrical connector including:
a connector body defining passages for receiving respective cables, and apertures for receiving fasteners to fasten the cables within the passages; and
one or more fasteners for engaging within respective apertures and as claimed in claim 1.

9. A shear fastener for an electrical connector, the fastener including a head from which a threaded shaft extends, the head defining a pair of polygonal portions separated by a recess so that an endmost one of the polygonal portions can be separated from the fastener by shearing as the fastener is tightened within the connector, separation of opposite corners of the endmost polygonal portion being different than separation of opposite corners of the other polygonal portion.

10. A shear fastener as claimed in claim 9, wherein the recess is inwardly tapered and endlessly extends around the head, each polygonal portion being hexagonal.

11. A shear fastener as claimed in claim 9, wherein the head defines a cap extending from the polygonal portions, the cap defining an endless clamping recess located between a resilient outer skirt and a central hub.

12. A shear fastener as claimed in claim 11, wherein the cap defines a flat roof surface against which a tightening tool can be pressed during tightening of the fastener.

13. A shear fastener as claimed in claim 11, wherein the shaft defines a ribbed tip which can be force fitted into a cavity defined in the hub, a locating ledge separating the ribbed tip from a threaded portion.

14. A shear fastener for an electrical connector, the elongate fastener including a head from which a shaft extends, the head defining a pair of portions separated by a recess so that an endmost one of the portions can be separated from the fastener by shearing as the fastener is tightened within the connector, the endmost portion having a cross sectional area transverse to the fastener different than the other portion.

15. A shear fastener as claimed in claim 14, wherein the recess is inwardly tapered and endlessly extends around the head, each portion being hexagonal.

16. A shear fastener as claimed in claim 14, wherein the head defines a cap extending from the portions, the cap defining an endless clamping recess located between a resilient outer skirt and a central hub.

17. A shear fastener as claimed in claim 16, wherein the cap defines a flat roof surface against which a tightening tool can be pressed during tightening of the fastener.

18. A shear fastener as claimed in claim 16, wherein the shaft defines a ribbed tip which can be forced fitted into a cavity defined in the hub, a locating ledge separating the ribbed tip from a threaded portion of the shaft.

19. A shear fastener as claimed in claim 14, wherein the endmost portion has a cross sectional area transverse to the fastener greater than the other portion.
